(19) United States
(12) Patent Application Publication
(10) Pub. No.: US 2026/0010103 A1
(43) Pub. Date: Jan. 8, 2026

(54) IMAGE FORMATION CONTROLLING METHOD AND IMAGE FORMING APPARATUS

(71) Applicant: KYOCERA Document Solutions Inc., Osaka (JP)

(72) Inventor: Masayuki Mochizuki, Osaka (JP)

(21) Appl. No.: 19/255,314

(22) Filed: Jun. 30, 2025

(30) Foreign Application Priority Data
Jul. 4, 2024 (JP) 2024-108068

(51) Int. Cl. G03G 15/20; G03G 15/00

(52) U.S. Cl. CPC G03G 15/2039; G03G 15/2064; G03G 15/5029; G03G 2215/00734; G03G 2215/2025

(57) ABSTRACT

A processor derives an index value of an amount of toner transferred to a sheet on the basis of data of an output image. The processor obtains size information indicating size of the sheet. The processor sets target temperature of fixing temperature depending on the index value and the size information. The processor controls an amount of power to be supplied to a heater under feedback control based on sensed fixing temperature and the target temperature. The sensed fixing temperature is sensed in a fixing device that applies pressure to an image of the toner transferred to the sheet using a pressure portion while heating the image of the toner using the heater.

### INCORPORATION BY REFERENCE

This application is based upon and claims the benefit of priority from the corresponding Japanese Patent Application No. 2024-108068 filed on July 4, 2024, the entire contents of which are incorporated herein by reference.

### BACKGROUND

This disclosure relates to an image formation controlling method and an image forming apparatus that each control the fixing temperature of a fixing device which fixes a toner image onto a sheet.

In an electrophotographic image forming apparatus, a fixing device applies pressure to a toner image transferred to a sheet using a pressure portion while heating the toner image using a heater. The fixing temperature of the fixing device influences the quality of an image formed on the sheet.

In addition, it has been known that the fixing temperature is controlled on the basis of image data.

### SUMMARY

An image formation controlling method according to an aspect of this disclosure includes deriving, by a processor, an index value of an amount of toner transferred to a sheet on the basis of data of an output image. Furthermore, the image formation controlling method includes obtaining, by the processor, size information indicating size of the sheet. Furthermore, the image formation controlling method includes setting, by the processor, target temperature of fixing temperature depending on the index value and the size information. Furthermore, the image formation controlling method includes controlling, by the processor, an amount of power to be supplied to a heater under feedback control based on sensed fixing temperature and the target temperature. The sensed fixing temperature is sensed in a fixing device that applies pressure to an image of the toner transferred to the sheet using a pressure portion while heating the image of the toner using the heater.

An image forming apparatus according to another aspect of this disclosure includes a transfer device, a fixing device, a fixing temperature sensing portion, and the processor that implements the image formation controlling method. The transfer device transfers a toner image to a sheet. The fixing device applies pressure to the toner image transferred to the sheet using a pressure portion while heating the toner image using a heater. The fixing temperature sensing portion senses the temperature of the fixing device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to a first embodiment.

FIG. 2 is a configuration diagram of a fixing device in the image forming apparatus according to the first embodiment.

FIG. 3 is a block diagram showing a configuration of a control device in the image forming apparatus according to the first embodiment.

FIG. 4 is a flowchart showing an example of a procedure of a target temperature setting process in the image forming apparatus according to the first embodiment.

FIG. 5 is a diagram of a peripheral portion of a plurality of sheet sensors in an image forming apparatus according to a second embodiment. FIG. 6 is a flowchart showing an example of a procedure of a target temperature setting process in the image forming apparatus according to the second embodiment.

### DETAILED DESCRIPTION

Hereinafter, embodiments of this disclosure will be described with reference to the drawings. It is noted that the following embodiments are specific examples of this disclosure and do not limit the technical scope of this disclosure.

### [First Embodiment: Configuration of Image Forming Apparatus 10]

An image forming apparatus 10 according to a first embodiment executes a print process by electrophotography. The print process is a process of forming an image on a sheet 9.

The image forming apparatus 10 includes a sheet conveying device 3, a printing device 4, a control device 8, an operation device 801, a display device 802, and the like. A housing 1 composes the body of the image forming apparatus 10 and includes the printing device 4.

The sheet conveying device 3 includes a sheet feeding device 30 and a plurality of conveying roller pairs 31. The sheet feeding device 30 feeds the sheet 9 stored in a sheet storing portion 2 to a conveyance path 300 in the housing 1.

The plurality of conveying roller pairs 31 is rotationally driven by unillustrated motors. The plurality of conveying roller pairs 31 conveys the sheet 9 along the conveyance path 300 by rotating with the sheet 9 nipped in between.

The plurality of conveying roller pairs 31 includes a registration roller pair 31a and a discharge roller pair 31b. The registration roller pair 31a temporarily stops conveying the sheet 9 and adjusts the timing to convey the sheet 9 to the printing device 4. The discharge roller pair 31b discharges the sheet 9 onto a discharge tray 101 from a discharge port of the conveyance path 300.

The sheet conveying device 3 includes a sheet sensor 32 that senses the sheet 9 in the conveyance path 300 (see ). For example, the sheet sensor 32 includes a displacement member that is displaced by coming into contact with the sheet 9 and a light sensor that senses the displacement of the displacement member.

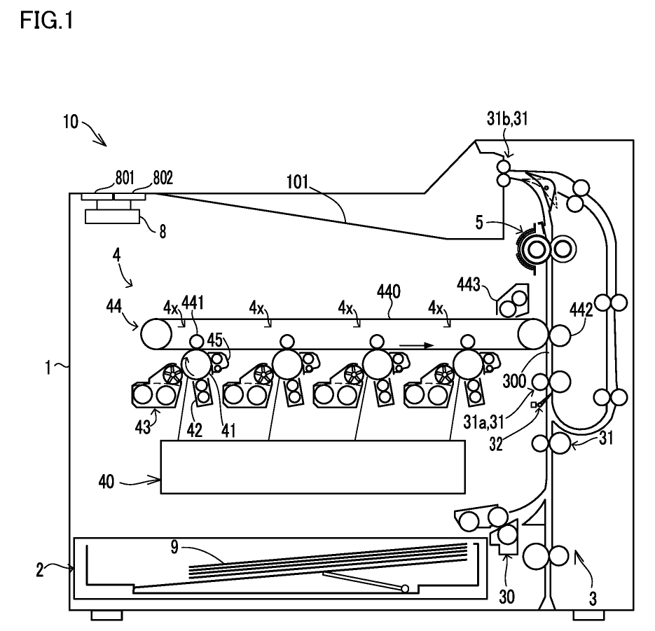

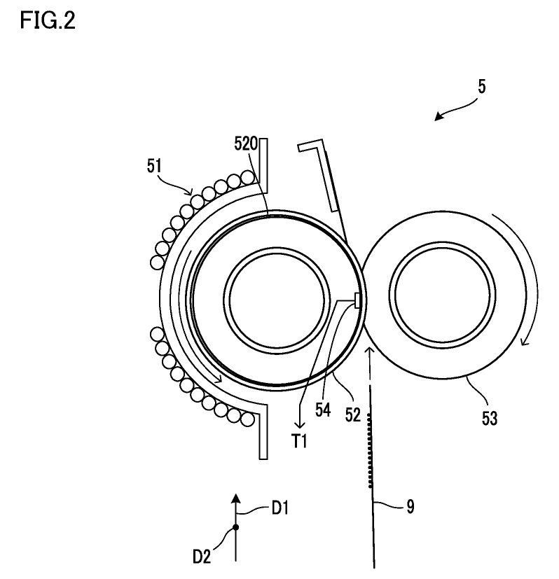

In the example shown in FIG. 1, the sheet sensor 32 is disposed on the upstream side of the registration roller pair 31a in the conveyance path 300 in a sheet conveying direction D1. The sheet sensor 32 is an example of a sheet sensing portion.

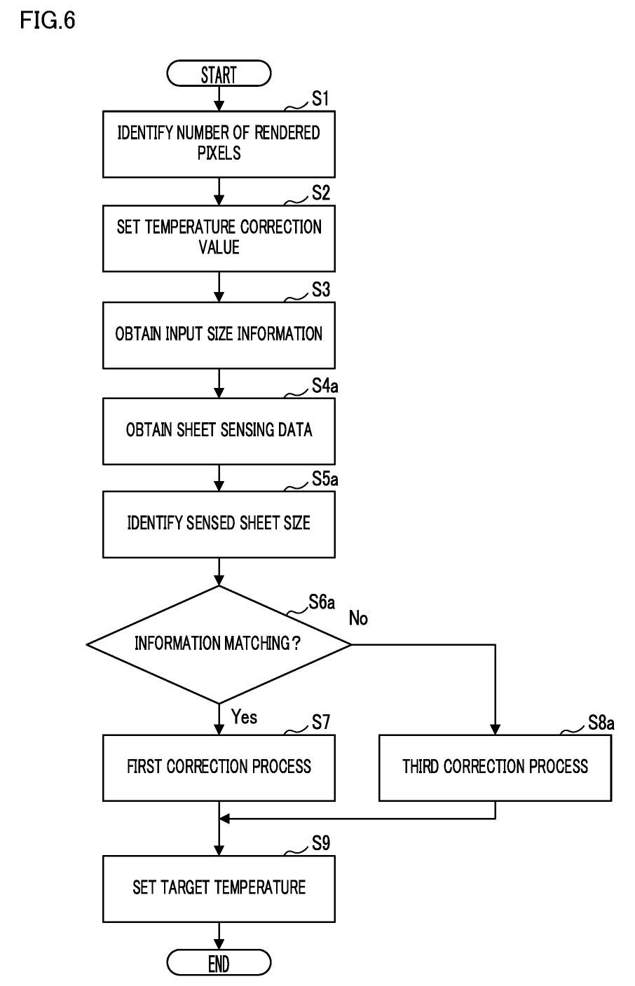

It is noted that a width direction D2 of the conveyance path 300 is a direction orthogonal to the sheet conveying direction D1 in FIGS. 2 and 5. The width direction D2 is a direction along the rotation axis of each of the conveying roller pairs 31 and the rotation axis of a pressure roller 53.

The registration roller pair 31a stops when a predefined time passes after the sheet 9 is sensed by the sheet sensor 32. This causes the registration roller pair 31 a to stop with the tip of the sheet 9 nipped in between. After that, the registration roller pair 31a resumes conveying the sheet 9 in synchronization with the formation of the toner image by the printing device 4.

The printing device 4 includes one or more image forming portions 4x, a laser scanning unit 40, a transfer device 44, and a fixing device 5. The image forming portions 4x each generate a toner image.

In this embodiment, the image forming apparatus 10 is a tandem-type color- image forming apparatus. The printing device 4 therefore includes the four image forming portions 4x corresponding to toners of the four colors of yellow, cyan, magenta, and black.

Each of the image forming portions 4x includes a drum-shaped photoconductor 41, a charging device 42, a developing device 43, a drum cleaning device 45, and the like.

In this embodiment, the transfer device 44 includes an intermediate transfer belt 440, four primary transfer rollers 441 corresponding to the four image forming portions 4x, a secondary transfer roller 442, and a belt cleaning device 443.

In each of the image forming portions 4x, the photoconductor 41 rotates and the charging device 42 charges a surface of the photoconductor 41. Furthermore, the laser scanning unit 40 writes an electrostatic latent image on the surface of the photoconductor 41 by scanning the surface of the photoconductor 41 with laser light. The photoconductor 41 is an example of an image-carrying member.

Furthermore, the developing device 43 supplies the surface of the photoconductor 41 with the toner to develop the electrostatic latent image into the toner image.

The transfer device 44 transfers the toner images to the sheet 9 in the conveyance path 300. In the transfer device 44, the primary transfer rollers 441 transfer the toner images on the surface of the photoconductors 41 to a surface of the intermediate transfer belt 440. This forms the color toner image on the surface of the intermediate transfer belt 440.

The secondary transfer roller 442 transfers the toner image formed on the intermediate transfer belt 440 to the sheet 9 at a transfer position in the conveyance path 300.

Additionally, in a case where the image forming apparatus 10 is a monochrome-image forming apparatus, the secondary transfer roller 442 transfers the toner images on the photoconductors 41 to the sheet 9.

The drum cleaning devices 45 each remove waste toner remaining on the surface of the photoconductor 41. The belt cleaning device 443 removes waste toner remaining on the surface of the intermediate transfer belt 440.

The fixing device 5 applies pressure to the toner image transferred to the sheet 9 at a fixation position in the conveyance path 300 while heating the toner image, thereby fixing the toner image onto the sheet 9. The fixation position is a more downstream position in the sheet conveying direction D1 than the transfer position.

The fixing device 5 includes a heater 51, a fixing member 52, and the pressure roller 53. The heater 51 heats the fixing member 52. The fixing member 52 heats the toner image by coming into contact with the toner image on the sheet 9. That is, the heater 51 heats the toner image on the sheet 9 through the fixing member 52. The pressure roller 53 biases the sheet 9 toward the fixing member 52.

The pressure roller 53 and the fixing member 52 hereby apply pressure to the toner image on the sheet 9. The pressure roller 53 is an example of a pressure member.

For example, the pressure roller 53 includes a tubular rigid base member and an elastic member layer formed on the outer periphery of the rigid base member.

In the example shown in FIG. 2 , the fixing member 52 is an annular belt member supported by a support tube 520 so as to be rotatable. The pressure roller 53 rotates and the fixing member 52 rotates following the pressure roller 53.

A fixing temperature sensor 54 that senses the temperature of the fixing member 52 is disposed in the fixing device 5. For example, the fixing temperature sensor 54 is a thermistor. The fixing temperature sensor 54 is an example of a fixing temperature sensing portion that senses the temperature of the fixing device 5.

The temperature sensed by the fixing temperature sensor 54 will be referred to as sensed fixing temperature T1 below (see FIG. 2). The sensed fixing temperature T1 is used to control the amount of power to be supplied to the heater 51.

The operation device 801 is a device that receives a human operation and includes, for example, an operation button and a touch panel. The display device 802 is a device that displays information and includes, for example, a panel display device such as a liquid-crystal display unit.

The control device 8 executes various data processes. Furthermore, the control device 8 controls the devices such as the sheet conveying device 3, the printing device 4, and the display device 802.

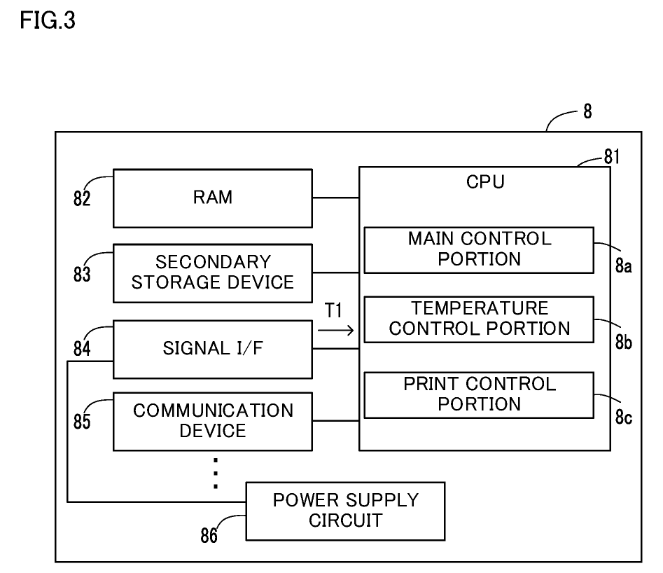

As shown in FIG. 3, the control device 8 includes a central processing unit (CPU) 81, and peripheral devices such as a random access memory (RAM) 82, a secondary storage device 83, and a signal interface 84. Furthermore, the control device 8 also includes a communication device 85, a power supply circuit 86, and the like.

The CPU 81 is a processor that executes a computer program to execute various data processes and control. The RAM 82 is a computer-readable volatile storage device. The RAM 82 temporarily stores the computer program that is executed by the CPU 81 and data that is outputted and referred to while the various processes are executed by the CPU 81.

The secondary storage device 83 is a computer-readable non-volatile storage device. The secondary storage device 83 is capable of storing and updating the computer program and the various kinds of data. For example, one of a flash memory or a hard disk drive or both a flash memory and a hard disk drive are adopted as the secondary storage device 83.

The signal interface 84 converts signals output from various sensors such as the fixing temperature sensor 54 into digital data and transmits the converted digital data to the CPU 81. Furthermore, the signal interface 84 converts a control instruction output from the CPU 81 into a control signal and transmits the control signal to a control target device.

The communication device 85 communicates with another device such as a host device through a communication network such as a LAN. The CPU 81 transmits and receives data to and from the other device through the communication device 85.

The power supply circuit 86 supplies power to the heater 51 of the fixing device 5. The power supply circuit 86 adjusts the amount of power to be supplied to the heater 51 in accordance with a power supply instruction received from the CPU 81 through the signal interface 84.

The CPU 81 includes a plurality of processing modules implemented by executing the computer program. The plurality of processing modules includes a main control portion 8a, a temperature control portion 8b, a print control portion 8c, and the like.

The main control portion 8a executes start control of causing various processes to start in response to an operation on the operation device 801, control over the display device 802, and the like.

The temperature control portion 8bcontrols the amount of power to be supplied to the heater 51 of the fixing device 5 under feedback control based on a comparison between the sensed fixing temperature T1 and target temperature. The temperature control portion 8bcontrols the amount of power to be supplied to the heater 51 to control the amount of heat to be generated by the heater 51.

As described below, the temperature control portion 8b sets the target temperature on the basis of the data of an output image.

The power supply circuit 86 supplies power to the heater 51 of the fixing device 5. The temperature control portion 8b controls the amount of power to be supplied to the heater 51 by outputting the power supply instruction to the power supply circuit 86.

The print control portion 8c controls the sheet conveying device 3, the laser scanning unit 40, the four image forming portions 4x, and the transfer device 44. The print control portion 8c causes the printing device 4 to execute the print process in synchronization with the conveyance of the sheet 9.

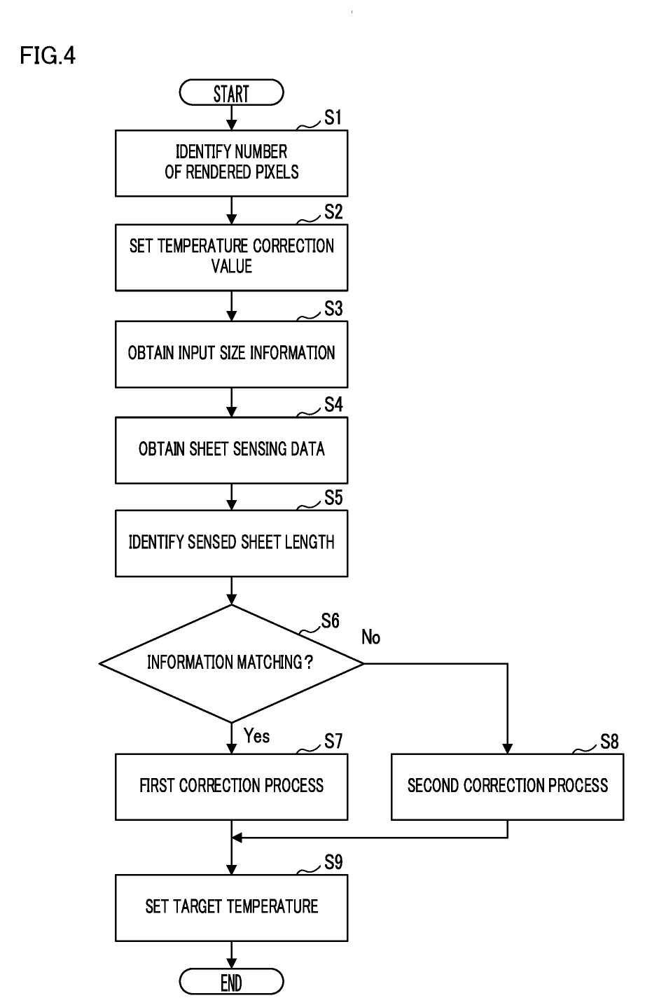

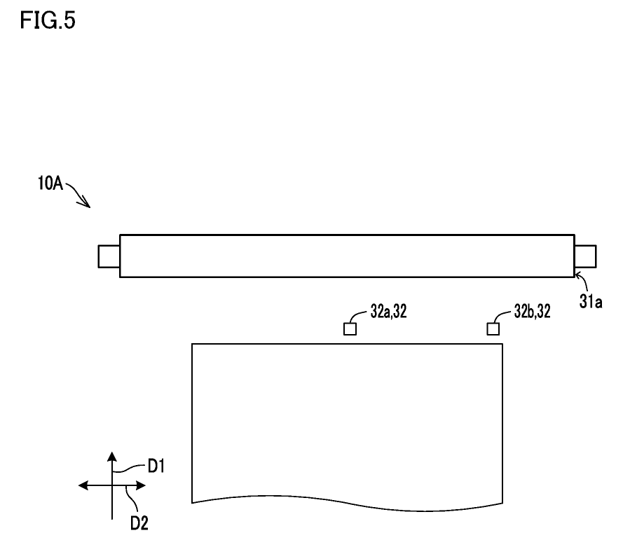

Incidentally, the fixing performance of the fixing device 5 is influenced by the amount of heat dissipated to the sheet 9 from the heater 51. To set the target temperature corresponding to the amount of heat dissipated to the sheet 9 from the heater 51, the temperature control portion 8b executes a target temperature setting process described below (see FIG. 4).

Furthermore, the temperature control portion 8b executes the feedback control based on the comparison between the sensed fixing temperature T1 and the target temperature set through the target temperature setting process.

The feedback control is control of adjusting the amount of power to be supplied to the heater 51 depending on the difference between the target temperature and the sensed fixing temperature T1. For example, the feedback control is PI control or PID control having the target temperature and the sensed fixing temperature T1 as inputs.

The temperature control portion 8b executes the feedback control when the print process is executed. The target temperature setting process and the feedback control are examples of a process of implementing an image formation controlling method that controls the image forming apparatus 10. The CPU 81 including the temperature control portion 8b is an example of a processor that implements the image formation controlling method.

### [Target Temperature Setting Process]

An example of a procedure of the target temperature setting process will be described below with reference to the flowchart shown in FIG. 4.

In the following description, S1, S2, ... represent the identification signs of a plurality of steps in the target temperature setting process. The temperature control portion 8b first executes the process of step S1 in the target temperature setting process.

### <Step S1>

In step S1, the temperature control portion 8b identifies the number of rendered pixels in one page on the basis of the data of an output image. The number of rendered pixels is an example of an index value of the amount of toner transferred to the sheet 9.

It is noted that the temperature control portion 8b may identify the total value of weights on the numbers of rendered pixels for the respective development colors in one page as the index value of the amount of toner transferred to the sheet 9 on the basis of the data of the output image.

In addition, the temperature control portion 8b may identify the rendering ratio of a unit image region as the index value of the amount of toner transferred to the sheet 9 on the basis of the data of the output image.

The temperature control portion 8b executes the process of step S2 after executing the process of step S1.

### <Step S2>

In step S2, the temperature control portion 8b sets a temperature correction value depending on the number of rendered pixels. The temperature correction value is a correction value of reference target temperature. The reference target temperature is a reference value of the target temperature in the feedback control.

The temperature control portion 8b sets the larger temperature correction value in the case of a larger number of rendered pixels rather than a smaller number of rendered pixels. The temperature control portion 8b executes the process of step S3 after executing the process of step S2.

### <Step S3>

In step S3, the temperature control portion 8b obtains input size information indicating the size of the sheet 9 stored in the sheet storing portion 2. The input size information is information input in advance through the operation device 801 or the communication device 85.

The temperature control portion 8b executes the process of step S4 after executing the process of step S3.

### <Step S4>

In step S4, the temperature control portion 8b obtains sheet sensing data indicating the sensing status of the sheet 9 by the sheet sensor 32. The sheet sensing data is information about a result of the sensing of the sheet 9 by the sheet sensor 32.

The temperature control portion 8b executes the process of step S5 after executing the process of step S4.

### <Step S5>

In step S5, the temperature control portion 8b identifies sensed sheet length corresponding to the sensing time of the sheet 9 by the sheet sensor 32 on the basis of the sheet sensing data. The sensed sheet length is length identified on the basis of a result of the sensing by the sheet sensor 32 and is the length of the sheet 9 in the sheet conveying direction D1.

In this embodiment, the sensing time of the sheet 9 by the sheet sensor 32 from the time when the registration roller pair 31a resumes conveying the sheet 9 after temporarily stopping conveying the sheet 9 indicates the sensed sheet length.

More specifically, the temperature control portion 8b derives, as the sensed sheet length, the value obtained by adding up the product of the sheet conveyance speed of the registration roller pair 31 a and the sensing time and a predefined constant.

In this embodiment, the input size information and the sheet sensing data are examples of size information indicating the size of the sheet 9. The temperature control portion 8b executes the process of step S6 after executing the process of step S5.

### <Step S6>

In step S6, the temperature control portion 8b determines whether or not the input size information matches the sensed sheet length.

For example, in a case where the sheet length identified by the input size information falls within a permissible range based on the sensed sheet length, the temperature control portion 8b determines that the input size information matches the sensed sheet length. In contrast, in a case where the sheet length identified by the input size information falls out of the permissible range, the temperature control portion 8b determines that the input size information does not match the sensed sheet length.

When it is determined that the input size information matches the sensed sheet length, the temperature control portion 8b executes the process of step S7. In contrast, when it is determined that the input size information does not match the sensed sheet length, the temperature control portion 8b executes the process of step S8.

### <Step S7>

In step S7, the temperature control portion 8b executes a first correction process that is a process of correcting the temperature correction value set in step S2.

The temperature control portion 8b corrects the temperature correction value depending on the input size information in the first correction process. The temperature control portion 8b identifies the sheet area corresponding to the input size information and corrects the temperature correction value to a larger value in the case of the larger sheet area rather than in the case of the smaller sheet area.

Additionally, in a case where the sheet area corresponding to the input size information falls within a reference area range defined in advance, the temperature control portion 8b retains the temperature correction value as set in step S2.

The temperature control portion 8b executes the process of step S9 after executing the process of step S7.

### <Step S8>

In step S8, the temperature control portion 8b executes a second correction process that is a process of correcting the temperature correction value set in step S2.

The temperature control portion 8b corrects the temperature correction value depending on the sensed sheet length in the second correction process. The temperature control portion 8b corrects the temperature correction value to a larger value in the case of the greater sensed sheet length rather than in the case of the less sensed sheet length.

Additionally, in a case where the sensed sheet length falls within a reference length range defined in advance, the temperature control portion 8b retains the temperature correction value as set in step S2.

The temperature control portion 8b executes the process of step S9 after executing the process of step S8.

### <Step S9>

In step S9, the temperature control portion 8b corrects the reference target temperature using the temperature correction value set in step S7 or step S8, thereby setting the target temperature. This sets the target temperature corresponding to the index value of the amount of toner transferred to the sheet 9 and the size information.

That is, in a case where the input size information matches the sensed sheet length, the temperature control portion 8b sets the target temperature depending on the input size information (steps S7 and S9). In contrast, in a case where the input size information does not match the sensed sheet length, the temperature control portion 8b sets the target temperature depending on the sensed sheet length (steps S8 and S9).

The temperature control portion 8b controls the amount of power to be supplied to the heater 51 of the fixing device 5 under the feedback control based on the comparison between the sensed fixing temperature T1 and the target temperature set in step S9.

The image forming apparatus 10 is adopted, thereby implementing appropriate fixing temperature control corresponding to the amount of heat dissipated to the sheet 9 from the heater 51 in the fixing device 5.

### [Second Embodiment]

Next, an image forming apparatus 10A according to a second embodiment will be described with reference to FIGS. 5 and 6.

The image forming apparatus 10A includes the plurality of sheet sensors 32 (see FIG. 5 ). The plurality of sheet sensor 32 senses the sheet 9 at respective different positions in the width direction D2 of the conveyance path 300 in the conveyance path 300.

The configuration of the image forming apparatus 10A is different from the configuration of the image forming apparatus 10 in that the plurality of sheet sensors 32 is provided. In the example shown in FIG. 5, the sheet conveying device 3 of the image forming apparatus 10A includes a first sheet sensor 32a and a second sheet sensor 32b that sense the sheet 9 at respective different positions in the width direction D2.

### [Target Temperature Setting Process]

An example of a procedure of the target temperature setting process in this embodiment will be described below with reference to the flowchart shown in FIG. 6. Differences between the procedure of the target temperature setting process shown in FIG. 6 and the procedure shown in FIG. 4 will be described below.

The procedure of the target temperature setting process shown in FIG. 6 is a procedure obtained by replacing step S4, step S5, step S6, and step S8 shown in with step S4a, step S5a, step S6a, and step S8a, respectively.

### <Step S4a>

In step S4a, the temperature control portion 8b obtains sheet sensing data indicating the sensing status of the sheet 9 by the plurality of sheet sensors 32. The sheet sensing data is information about results of the sensing of the sheet 9 by the plurality of sheet sensors 32.

The temperature control portion 8b executes the process of step S5a after executing the process of step S4a.

### <Step S5a>

In step S5a, the temperature control portion 8b identifies sensed sheet size that is the size of the sheet 9 corresponding to the results of the sensing of the sheet 9 by the plurality of sheet sensors 32 on the basis of the sheet sensing data.

Specifically, the temperature control portion 8b identifies sensed sheet width that is the size of the sheet 9 in the width direction D2 depending on the number of effective sensors that sense the sheet 9 among the plurality of sheet sensors 32.

In the example shown in FIG. 5 , in a case where only the first sheet sensor 32a is the effective sensor, the temperature control portion 8b identifies a first width range as the sensed sheet width. In a case where the first sheet sensor 32a and the second sheet sensor 32b are the effective sensors, the temperature control portion 8b identifies a second width range greater than the first width range as the sensed sheet width. Both the first width range and the second width range are ranges of the width size of the sheet 9 defined in advance.

Furthermore, the temperature control portion 8b identifies the sensed sheet length corresponding to the sensing time of the sheet 9 by the effective sensor as in step S5 in FIG. 4. The temperature control portion 8b identifies the sensed sheet width and the sensed sheet length as the sensed sheet size.

The temperature control portion 8b executes the process of step S6a after executing the process of step S5a.

### <Step S6a>

In step S6a, the temperature control portion 8b determines whether or not the input size information matches the sensed sheet size.

For example, in a case where the sheet width and the sheet length identified by the input size information respectively fall within the permissible ranges based on the sensed sheet width and the sensed sheet length, the temperature control portion 8b determines that the input size information matches the sensed sheet size. In contrast, in a case where at least one of the sheet width and the sheet length identified by the input size information falls out of the permissible range, the temperature control portion 8b determines that the input size information does not match the sensed sheet size.

When it is determined that the input size information matches the sensed sheet size, the temperature control portion 8b executes the process of step S7. In contrast, when it is determined that the input size information does not match the sensed sheet size, the temperature control portion 8b executes the process of step S8a.

### <Step S8a>

In step S8a, the temperature control portion 8b executes a third correction process that is a process of correcting the temperature correction value set in step S2.

The temperature control portion 8b corrects the temperature correction value depending on the sensed sheet size in the third correction process. The temperature control portion 8b corrects the temperature correction value to a larger value in a case where the sheet 9 corresponding to the sensed sheet size has larger area rather than in a case where the sheet 9 corresponding to the sensed sheet size has smaller area.

Additionally, in a case where the sensed sheet size falls within a reference size range defined in advance, the temperature control portion 8b retains the temperature correction value as set in step S2.

The temperature control portion 8b executes the process of step S9 after executing the process of step S8a. In step S9 in this embodiment, the temperature control portion 8b corrects the reference target temperature using the temperature correction value set in step S7 or step S8a, thereby setting the target temperature.

That is, in a case where the input size information matches the sensed sheet size, the temperature control portion 8b sets the target temperature depending on the input size information (steps S7 and S9). In contrast, in a case where the input size information does not match the sensed sheet size, the temperature control portion 8b sets the target temperature depending on the sensed sheet size (steps S8a and S9).

In a case where the image forming apparatus 10A is adopted, an effect similar to the effect obtained in a case where the image forming apparatus 10 is adopted is also obtained.

### [Supplementary Notes of Invention]

The gist of the invention extracted from the embodiments described above will be supplementarily noted below. It is noted that the respective configurations and the respective processing functions described in the following supplementary notes can be sorted out and used in any combination.

### <Supplementary Note 1>

An image formation controlling method including: deriving, by a processor, an index value of an amount of toner transferred to a sheet on the basis of data of an output image; obtaining, by the processor, size information indicating size of the sheet; setting, by the processor, target temperature of fixing temperature depending on the index value and the size information; and controlling, by the processor, an amount of power to be supplied to a heater under feedback control based on sensed fixing temperature and the target temperature, the sensed fixing temperature being sensed in a fixing device that applies pressure to an image of the toner transferred to the sheet using a pressure portion while heating the image of the toner using the heater.

### <Supplementary Note 2>

The image formation controlling method according to Supplementary Note 1, in which the size information includes input size information input through an operation device or a communication device.

### <Supplementary Note 3>

The image formation controlling method according to Supplementary Note 2, in which the size information includes information about a result of sensing of the sheet by a sheet sensing portion that senses the sheet in a conveyance path of the sheet, and the processor identifies sensed sheet length corresponding to sensing time of the sheet by the sheet sensing portion, and sets the target temperature depending on the input size information in a case where the input size information matches the sensed sheet length and sets the target temperature depending on the sensed sheet length in a case where the input size information does not match the sensed sheet length.

### <Supplementary Note 4>

The image formation controlling method according to Supplementary Note 2, in which the size information includes information about results of sensing by the plurality of sheet sensing portions, the plurality of sheet sensing portions sensing the sheet at respective different positions in a width direction of a conveyance path of the sheet in the conveyance path; and the processor identifies sensed sheet size corresponding to the results of the sensing by the plurality of sheet sensing portions, and sets the target temperature depending on the input size information in a case where the input size information matches the sensed sheet size and sets the target temperature depending on the sensed sheet size in a case where the input size information does not match the sensed sheet size.

### <Supplementary Note 5>

The image formation controlling method according to any one of Supplementary Notes 1 to 4, in which the setting the target temperature includes setting, by the processor, a correction value of reference target temperature depending on the index value, correcting, by the processor, the correction value depending on the size information, and setting, by the processor, the target temperature by correcting the reference target temperature using the corrected correction value.

### <Supplementary Note 6>

An image forming apparatus including: a transfer device configured to transfer a toner image to a sheet; a fixing device configured to apply pressure to the toner image transferred to the sheet using a pressure portion while heating the toner image using a heater; a fixing temperature sensing portion configured to sense temperature of the fixing device; and a processor configured to implement the image formation controlling method according to any one of Supplementary Notes 1 to 5.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. An image formation controlling method comprising: deriving, by a processor, an index value of an amount of toner transferred to a sheet on a basis of data of an output image; obtaining, by the processor, size information indicating size of the sheet; setting, by the processor, target temperature of fixing temperature depending on the index value and the size information; and controlling, by the processor, an amount of power to be supplied to a heater under feedback control based on sensed fixing temperature and the target temperature, the sensed fixing temperature being sensed in a fixing device that applies pressure to an image of the toner transferred to the sheet using a pressure portion while heating the image of the toner using the heater.

2. The image formation controlling method according to claim 1, wherein the size information includes input size information input through an operation device or a communication device.

3. The image formation controlling method according to claim 2, wherein the size information includes information about a result of sensing of the sheet by a sheet sensing portion that senses the sheet in a conveyance path of the sheet, and the processor identifies sensed sheet length corresponding to sensing time of the sheet by the sheet sensing portion, and sets the target temperature depending on the input size information in a case where the input size information matches the sensed sheet length and sets the target temperature depending on the sensed sheet length in a case where the input size information does not match the sensed sheet length.

4. The image formation controlling method according to claim 2, wherein the size information includes information about results of sensing by the plurality of sheet sensing portions, the plurality of sheet sensing portions sensing the sheet at
respective different positions in a width direction of a conveyance path of the sheet in the conveyance path; and the processor identifies sensed sheet size corresponding to the results of the sensing by the plurality of sheet sensing portions, and sets the target temperature depending on the input size information in a case where the input size information matches the sensed sheet size and sets the target temperature depending on the sensed sheet size in a case where the input size information does not match the sensed sheet size.

5. The image formation controlling method according to claim 1, wherein the setting the target temperature includes setting, by the processor, a correction value of reference target temperature depending on the index value, correcting, by the processor, the correction value depending on the size information, and setting, by the processor, the target temperature by correcting the reference target temperature using the corrected correction value.

6. An image forming apparatus comprising: a transfer device configured to transfer a toner image to a sheet; a fixing device configured to apply pressure to the toner image transferred to the sheet using a pressure portion while heating the toner image using a heater; a fixing temperature sensing portion configured to sense temperature of the fixing device; and a processor configured to implement the image formation controlling method according to claim 1.
